(19) United States
(12) Patent Application Publication
(10) Pub. No.: US 2026/0206765 A1
(43) Pub. Date: Jul. 23, 2026

(54) AN INSECT REPELLENT

(71) Applicants: UPL MAURITIUS LIMITED, Port Louis (MU); UPL EUROPE SUPPLY CHAIN GMBH, Rotkreuz/Risch (CH)

(72) Inventor: Andrea Bergamaschi, Cesena (IT)

(73) Assignees: UPL MAURITIUS LIMITED, Port Louis (MU); UPL EUROPE SUPPLY CHAIN GMBH, Rotkreuz/Risch (CH)

(21) Appl. No.: 19/157,862

(22) PCT Filed: Feb. 16, 2024
(86) PCT No.: PCT/IB2024/051482

§ 371 Date: Aug. 19, 2025

(30) Foreign Application Priority Data
Feb. 20, 2023 (IT) 102023000002862

(51) Int. Cl. A01N 59/02; A01N 25/02; A01P 17/00

(52) U.S. Cl. CPC A01N 59/02; A01N 25/02; A01P 17/00

(57) ABSTRACT

The present disclosure relates to a composition comprising sulphur for use as an insect repellent, and methods of uses thereof.

### FIELD OF INVENTION

The present disclosure relates to a pest repellent composition. More specifically, the present disclosure relates to a composition comprising sulphur for use as an insect repellent, and methods of uses thereof.

### BACKGROUND

Insects inflict injury to plants either directly or indirectly in their attempts to secure food. Damage caused by insect pests to the crops is a global issue which is responsible for huge crop losses, low yields, and poor quality of agricultural produce. Traditionally, crop protection measures rely on insecticidal applications to control insect pest population to arrest crop damage and agricultural loss. However, overuse of insecticides has presented multitude of problems in the present day. Use of insecticides has been accompanied with downsides such as excessive chemical exposure which can be harmful over prolonged durations, pest resistance to insecticides, endangering beneficial insects, birds, animals, and humans. The growing threat of higher crop losses due to pests needs to be countered by improved crop protection methods such as integrated pest management.

Integrated pest management programs combine several pest management methods such as insecticides, pheromones, pest attractants, baits or traps, and pest repellents. The demand for chemical pest repellents is increasing due to their cost effectiveness, relatively fast action, ease of application, and easy availability. However, the growth in pest resistance against chemical pest repellents is predicted to boost the demand for natural or biological pest repellents. The natural or biological pest repellents possess less effect on human health and environment which is predicted to boost the demand for biological pest repellents, which is more suitable in the wake of stringent government policies seeking ban on harmful chemicals. Thus, to overcome the threats posed by the chemical crop protection measures, it is important to look for more natural, harmless, and environment-friendly substances as pest repellents which present more efficacy in insect pest management and preventing crop losses.

Sulphur has traditionally been used as a natural fungicide, particularly for vines and grapes. In recent times, its insecticidal uses and preventive uses were discovered and demonstrated.

Liquid and solid compositions of sulphur have been reported to cause mortality in insect pests. Solid compositions of sulphur have been reported to be applied at very high rates to see a visible repellent effect against certain insect pests, with chances of toxicity to the plants or the insects. Therefore, there is a continuing need in the art for new compositions comprising sulphur which are effective as repellents and are safe to the plants and insects. There is a need for novel compositions comprising sulphur which provide repellent effect against insect pests when applied at lower rates.

Thus, it is an objective of the present disclosure to provide a composition comprising sulphur for use as an insect repellent. It is another objective of the present disclosure to provide a composition comprising sulphur for use as an insect repellent which is effective and safe to the plants and insects. It is yet another objective of the present disclosure to provide a composition comprising sulphur for use as an insect repellent which is effective at lower dosage rates. It is also an objective of the present disclosure to provide a composition comprising sulphur for use as an insect repellent which is applied at pre-harvest stage. It is also an objective of the present disclosure to control insect pests and prevention of damage to plants or crops by insect pests with an insect repellent composition comprising sulphur.

### SUMMARY

In accordance with the objectives of the present disclosure, an aspect of the present disclosure provides a liquid composition comprising sulphur for use as an insect pest repellant.

An aspect of the present disclosure provides a method of repelling insect pests comprising contacting a locus, a plant, or a part thereof with a liquid composition comprising sulphur. In an embodiment, the liquid composition comprising sulphur is an insect pest repellent.

An aspect of the present disclosure provides a method of controlling insect pest population in a given area, wherein the method comprises contacting a locus, a plant, or a part thereof in the given area with a liquid composition comprising sulphur.

An aspect of the present disclosure provides a method of preventing damage to a plant or a part thereof by an insect pest comprising contacting a locus, a plant, or a part thereof with a liquid composition comprising sulphur, wherein the liquid composition comprising sulphur is an insect pest repellent.

An aspect of the present disclosure provides a method of increasing yield of a plant or a part thereof comprising contacting a locus, a plant, or a part thereof with a liquid composition comprising sulphur, wherein the liquid composition comprising sulphur is an insect pest repellent.

Another aspect of the present disclosure provides a use of a liquid composition comprising sulphur as an insect pest repellant.

### DESCRIPTION

The inventors of the present invention observed that liquid compositions of sulphur exerted a repellent effect on insect pests. It was a surprising finding that liquid compositions performed better at insect repellency compared to solid formulations. For the present disclosure, the invention based on the surprising finding by the inventors has been described in great detail through embodiments herein.

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present disclosure in detail, it is to be understood that this invention is not limited to particularly exemplified parameters, methods of use or composition that may of course, vary. It is also to be understood that the terminology used herein is for the purpose of describing embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate). As used herein, the term “about” refers to a measurable value such as a parameter, an amount, a temporal duration, and the like and is meant to include variations of +/−15% or less, specifically variations of +/−10% or less, more specifically variations of +/−5% or less, even more specifically variations of +/−1% or less, and still more specifically variations of +/−0.1% or less of and from the particularly recited value, in so far as such variations are appropriate to perform in the disclosure described herein.

Recitation of ranges of values are merely intended to serve as a shorthand method of referring individually to each separate value falling within the range, unless otherwise indicated herein, and each separate value is incorporated into the specification as if it were individually recited herein. All provided ranges of values are intended to include the end points of the ranges, as well as values between the end points, and are independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

As used herein, the term “locus” refers to an area, a plant or a part thereof, a crop or a part thereof which is infested by or prone to infestation by insect pests. It includes any habitat, breeding ground, plant, plant propagation material, soil, area, material or environment in which a crop is growing or may grow, or where the pest breeds, attacks, may breed or may attack.

In the context of this specification, the term “repellent” refers to a substance which repels, deters insect pests and is able to keep the insect pests away. It also includes a substance capable of preventative action against insect pests, control of insect infestation and subsequent control of damage to the plant. The specification particularly refers to a liquid composition of sulphur which acts as a repellent against insect pests. Said composition is also understood to have a deterrent effect against insect pests, preventative action against insect pests, control of insect infestation and subsequent control of damage to the plant.

In the context of this specification, the term “sulfur” refers to elemental sulphur, allotropic forms of sulphur, or its complexed forms such as salts, derivatives, or compounds of sulphur with oxidation states such as −2, +4, and +6. The term also encompasses sulfides which may be present alongside the other forms described herein.

An embodiment of the present disclosure provides a liquid composition for use as an insect pest repellant, wherein the composition comprises sulphur.

In an embodiment, sulphur is present in the composition as elemental sulphur, allotropic forms of sulphur, or its complexed forms such as salts, derivatives, or compounds of sulphur with oxidation states such as −2, +4, and +6.

In an embodiment, the liquid composition comprises sulphur in an amount ranging from about 0.1% to about 99% of the total weight or volume of the composition. In an embodiment, the liquid composition comprises sulphur in an amount ranging from about 1% to about 90% of the total weight or volume of the composition. In an embodiment, the liquid composition comprises sulphur in an amount ranging from about 5% to about 90% of the total weight or volume of the composition. In an embodiment, the liquid composition comprises sulphur in an amount ranging from about 5% to about 80% of the total weight or volume of the composition. In an embodiment, the liquid composition comprises sulphur in an amount ranging from about 5% to about 70% of the total weight or volume of the composition. In an embodiment, the liquid composition comprises sulphur in an amount ranging from about 8% to about 60% of the total weight or volume of the composition.

In a preferred embodiment, the liquid composition comprises sulphur in an amount ranging from about 8% to about 10% of the total weight or volume of the composition. In a preferred embodiment, the liquid composition comprises sulphur in an amount ranging from about 50% to about 60% of the total weight or volume of the composition. In a preferred embodiment, the liquid composition comprises sulphur in an amount ranging from about 50% w/w to about 60% w/w of the total weight of the composition.

In an embodiment, the liquid composition comprises about 1 g/L to about 1000 g/L of sulphur. In an embodiment, the liquid composition comprises about 10 g/L to about 950 g/L of sulphur. In an embodiment, the liquid composition comprises about 50 g/L to about 900 g/L of sulphur. In an embodiment, the liquid composition comprises about 75 g/L to about 875 g/L of sulphur. In an embodiment, the liquid composition comprises about 90 g/L to about 850 g/L of sulphur. In a preferred embodiment, the liquid composition comprises about 94 g/L of sulphur. In a preferred embodiment, the liquid composition comprises about 96 g/L of sulphur. In another preferred embodiment, the liquid composition comprises about 825 g/L of sulphur.

In an embodiment, the composition of the present disclosure further comprises a sulfide compound, an oil, or combinations thereof. It has been surprisingly found that the use of sulphur compound in the presence of, or containing, a sulfide compound leads to a synergistic combined repellency towards insects. Thus, in an embodiment, the combination of sulphur and the additional ingredient in the composition exerts more than additive repellent effect of individual actives.

In a preferred embodiment, the composition of the present disclosure further comprises a sulfide compound. In another embodiment, the sulfide compound is detected in the liquid composition comprising sulphur. In an embodiment, the sulfide compound is formed in said composition. In an embodiment, the sulfide compound is added to the said composition. In an embodiment, the sulfide compound may be hydrogen sulfide, dimethyl sulfide, copper sulfide, aluminium sulfide, sodium sulfide, mercury sulfide, cadmium sulfide, iron sulfide, zinc sulfide, diallyl sulfide, dimethyl disulfide, allyl methyl sulfide, carbon disulfide, or combinations thereof. In a preferred embodiment, the sulfide is a hydrogen sulfide.

In a preferred embodiment, the composition of the present disclosure further comprises an oil. In an embodiment, the oil may be a vegetable oil or a mineral oil. In an embodiment, the vegetable oil may be selected from olive oil, kapok oil, castor oil, palm oil, sunflower oil, camellia oil, coconut oil, sesame oil, corn oil, rice bran oil, peanut oil, cottonseed oil, soybean oil, rapeseed oil, linseed oil, tung oil, canola oil, corn oil, or combinations thereof. In an embodiment, the mineral oil may be selected from, but not limited to, paraffinum liquidum, petrolatum, cera microcristallina, microcrystalline wax, naphthenes, ozokerite, ceresine isoparaffin, paraffin and synthetic wax, aromatic oils, fuel oil, or combinations thereof. In a preferred embodiment, the oil is a mineral oil.

In an embodiment, the present disclosure provides a liquid composition for use as an insect pest repellant, wherein the composition comprises sulphur and a sulfide compound.

In an embodiment, the present disclosure provides a liquid composition for use as an insect pest repellant, wherein the composition comprises sulphur and an oil.

In an embodiment, the present disclosure provides a liquid composition for use as an insect pest repellant, wherein the composition comprises sulphur, a sulfide compound and an oil.

In an embodiment, the amount of sulfide compound in the composition is about 1% w/w or less.

In an embodiment, the amount of oil in the composition ranges from about 1% w/w to about 80% w/w. In an embodiment, the amount of oil in the composition ranges from about 10% w/w to about 70% w/w of the total weight of the composition. In an embodiment, the amount of oil in the composition ranges from about 20% w/w to about 60% w/w of the total weight of the composition. In an embodiment, the amount of oil in the composition ranges from about 30% w/w to about 50% w/w of the total weight of the composition. In an embodiment, the amount of oil in the composition ranges from about 35% w/w to about 45% w/w of the total weight of the composition.

In an embodiment, the amount of oil in the composition ranges from about 1 g/L to about 800 g/L. In an embodiment, the amount of oil in the composition ranges from about 50 g/L to about 700 g/L. In an embodiment, the amount of oil in the composition ranges from about 100 g/L to about 600 g/L. In an embodiment, the amount of oil in the composition ranges from about 200 g/L to about 500 g/L. In an embodiment, the amount of oil in the composition ranges from about 300 g/L to about 500 g/L. In an embodiment, the amount of oil in the composition ranges from about 350 g/L to about 550 g/L. In an embodiment, the amount of oil in the composition is 400 g/L.

In a preferred embodiment, the compositions of the present disclosure further comprise an agrochemically suitable excipient.

In an embodiment, the liquid composition of the present disclosure may be formulated as soluble (liquid) concentrates, suspension concentrates (SC), oil in water emulsions, water in oil emulsions, emulsifiable concentrates (EC), emulsions in water (EW), capsule suspensions (CS), suspoemulsions (SE), ZC formulations, oil dispersions. In a preferred embodiment, the liquid composition of sulphur is a suspension concentrate. In a preferred embodiment, the liquid composition of sulphur is an oil dispersion. In a preferred embodiment, the liquid composition of sulphur is an oil in water emulsion.

An embodiment of the present disclosure provides a liquid composition for use as an insect pest repellant, wherein the composition comprises sulphur and an agrochemically suitable excipient.

An embodiment of the present disclosure provides a liquid composition for use as an insect pest repellant, wherein the composition comprises sulphur, an additional ingredient such as a sulfide compound, an oil, or combinations thereof, and an agrochemically suitable excipient.

The agrochemically suitable excipient may be any one or a combination of adjuvants, co-solvents, surfactants, colorants, dispersants, emulsifiers, thickeners, antifreeze agents, biocides, anti-foam agents, stabilizers, wetting agents or a mixture thereof which may be optionally added to the compositions of the present invention.

The surfactants may be selected from non-ionic, anionic or cationic surfactants.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Cationic surfactants include alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl, or derivatives thereof.

According to an embodiment, antifoam agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Foot Olive Oil, Mono & Di Glyceride, Paraffin Oil, Paraffin Wax, Poly Propylene Glycol, Silicones Oil, Vegetable Fats, Vegetable Fats Sulfate, Vegetable Oil, Vegetable Oil Sulfate, Vegetable Wax, Vegetable Wax Sulfate, agents based on silicon or magnesium stearate.

In an embodiment, the composition of the present disclosure is effective in repelling insect pests.

An embodiment of the present disclosure provides a method of repelling insect pests comprising contacting a locus, a plant, or a part thereof with a liquid composition comprising sulphur.

In an embodiment, the liquid composition comprising sulphur is applied at a rate of less than 30,000 g ai/ha of sulphur. In an embodiment, the liquid composition comprising sulphur is applied at a rate of 25,000 g ai/ha of sulphur or less. In an embodiment, the liquid composition comprising sulphur is applied at a rate of 20,000 g ai/ha of sulphur or less. In an embodiment, the liquid composition comprising sulphur is applied at a rate of 15,000 g ai/ha of sulphur or less. In an embodiment, the liquid composition comprising sulphur is applied at a rate of 10,000 g ai/ha of sulphur or less.

It is noteworthy that application rate of liquid compositions of sulphur is a function of the application rate of its active ingredient sulphur and are accordingly adjusted to meet the sulphur active ingredient requirements.

In a preferred embodiment, the liquid composition comprising sulphur is applied at a rate of about 1 g ai/ha to about 29,999 g ai/ha, wherein g ai/ha represents the application rate of sulphur active ingredient. Preferably, the liquid composition comprising sulphur is applied at a rate of about 100 g ai/ha to about 25,000 g ai/ha; about 500 g ai/ha to about 22,500 g ai/ha; about 1000 g ai/ha to about 20,000 g ai/ha; about 1500 g ai/ha to about 17,500 g ai/ha; about 2000 g ai/ha to about 15,000 g ai/ha; about 2500 g ai/ha to about 12,500 g ai/ha; and 3000 g ai/ha to about 10,000 g ai/ha.

In an embodiment, sulphur is applied at a rate of less than 30,000 g ai/ha. In an embodiment, sulphur is applied at a rate of less than 30,000 g ai/ha. In an embodiment, sulphur is applied at a rate of 25,000 g ai/ha or less. In an embodiment, sulphur is applied at a rate of 20,000 g ai/ha or less. In an embodiment, sulphur is applied at a rate of 15,000 g ai/ha or less. In an embodiment, sulphur is applied at a rate of 10,000 g ai/ha or less.

In a preferred embodiment, sulphur is applied at a rate of about 1 g ai/ha to about 29,999 g ai/ha. Preferably, sulphur is applied at a rate of about 100 g ai/ha to about 25,000 g ai/ha; about 500 g ai/ha to about 22,500 g ai/ha; about 1000 g ai/ha to about 20,000 g ai/ha; about 1500 g ai/ha to about 17,500 g ai/ha; about 2000 g ai/ha to about 15,000 g ai/ha; about 2500 g ai/ha to about 12,500 g ai/ha; and 3000 g ai/ha to about 10,000 g ai/ha.

In an embodiment, the liquid composition comprising sulphur is applied at a rate of 1 ml/ha to about 40,000 ml/ha, wherein the ml/ha corresponds to the application rate of the whole composition. In an embodiment, the liquid composition comprising sulphur is applied at a rate of 1 ml/ha to about 36,000 ml/ha. In an embodiment, the liquid composition comprising sulphur is applied at a rate of 100 ml/ha to about 18,000 ml/ha. In an embodiment, the liquid composition comprising sulphur is applied at a rate of 1000 ml/ha to about 15,000 ml/ha. In an embodiment, the liquid composition comprising sulphur is applied at a rate of 2000 ml/ha to about 14,000 ml/ha. In an embodiment, the liquid composition comprising sulphur is applied at a rate of 3000 ml/ha to about 13,000 ml/ha. In an embodiment, the liquid composition comprising sulphur is applied at a rate of 4000 ml/ha to about 12,000 ml/ha.

In an embodiment, the composition of the present disclosure is applied at pre-harvest stage.

In an embodiment, the pest repellent liquid composition of the present disclosure may be tank mixed with agrochemically suitable excipients and applied at a locus where one or more crop is growing, or may be alternatively mixed with water, and then applied.

In an embodiment, the pest repellent liquid composition of the present disclosure may be tank mixed with the additional ingredient or ingredients and applied at a locus where one or more crop is growing. In an embodiment, the pest repellent liquid composition of the present disclosure and the additional ingredient or ingredients may be applied jointly, such as in a pre-mix or a tank-mix form; or separately, such as in succession or sequentially-in any sequence, with or without a time gap in between the applications.

In an embodiment, the pest repellent liquid composition may be applied in a diluted or an undiluted form. The pest repellent liquid composition may also be applied as a ready-to-use product.

In an embodiment, the pest repellent liquid compositions may be used for foliar application, ground application, or application to plant propagation materials.

In an embodiment, the pest repellent liquid compositions may be used in conjunction with pest traps, baits or lures.

An embodiment of the present disclosure provides a method of preventing or controlling insect pest population in a given area, wherein the method comprises contacting a locus, a plant, or a part thereof in the given area with a liquid composition comprising sulphur. In an embodiment, said composition further comprises an additional ingredient such as a sulfide compound, an oil, or combinations thereof.

An embodiment of the present disclosure provides a method of preventing damage to a plant or a part thereof comprising contacting a locus, a plant, or a part thereof with a liquid composition comprising sulphur. In an embodiment, said composition further comprises an additional ingredient such as a sulfide compound, an oil, or combinations thereof.

An embodiment of the present disclosure provides a method of increasing yield of a plant or a part thereof comprising contacting a locus, a plant, or a part thereof with a liquid composition comprising sulphur. In an embodiment, said composition further comprises an additional ingredient such as a sulfide compound, an oil, or combinations thereof.

In an embodiment, the liquid composition of the present disclosure comprising sulphur is an insect pest repellent.

In an embodiment, the pest repellent is effective in repelling pests of insects from the order of the lepidopterans (Lepidoptera), for example Acronicta major, Adoxophyes orana, Aedia leucomelas, Agrotis spp, such as Agrotis fucosa, Agrotis segetum, Agrotis ipsilon; Alabama argillacea, Anticarsia gemmatalis, Anticarsia spp., Argyresthia conjugella, Autographa gamma, Barathra brassicae, Buccuiatrix thurberielia, Bupalus piniarius, Cacoecia murinana, Cacoecia podana, Capua reticulana, Carpocapsa pomonella, Cheimatobia brumata, Chilo spp. such as Chilo suppressalis; Choristoneura fumiferana, Choristoneura occidentalis, Cirphis unipuncta, Clysia ambiguella, Cnaphalocerus spp., Cydia pomonella, Dendrolimus pini, Diaphania nitidalis, Diatraea grandiosella, Earias insulana, Elasmopalpus lignosellus, Ephestia cautella, Ephestia kuehniella, Eulecanium tiliae, Eupoecilia ambiguella, Euproctis chrysorrhoea, Euxoa spp., Evetria bouliana, Feltia spp, such as Feltia subterranean; Galleria mellonella, Grapholitha funebrana, Grapholitha molesta, Helicoverpa spp, such as Helicoverpa armigera, Helicoverpa zea; Heliothis spp, such as Heliothis armigera, Heliothis virescens, Heliothis zea; Hellula undalis, Hibernia defoliaria, Hofmannophila pseudospretella, Homona magnanima, Hyphantria cunea, Hyponomeuta padella, Hyponomeuta malinellus, Keiferia lycopersicella, Lambdina fiscellaria, Laphygma spp, such as Laphygma exigua; Leucoptera coffeella, Leucoptera scitella, Lithocolletis blancardella, Lithophane antennata, Lobesia botrana, Loxagrotis albicosta, Loxostege sticticalis, Lymantria spp, such as Lymantria dispar, Lymantria monacha; Lyonetia clerkella, Malacosoma neustria, Mamestra spp, such as Mamestra brassicae; Mods repanda, Mythimna separata, Orgyia pseudotsugata, Oria spp., Ostrinia spp, such as Ostrinia nubilalis; Oulema oryzae, Panolis flammea, Pectinophora spp. such as Pectinophora gossypiella; Peridroma saucia, Phalera bucephala, Phthorimaea spp. such as Phthorimaea operculella; Phyllocnistis citrella, Phytoptus spp. Such as Phytoptus avellanae, Pieris spp, such as Pieris brassicae, Pieris rapae; Plathypena scabra, Plutella maculipennis, Plutella xylostella, Prodenia spp., Pseudaletia spp., Pseudoplusia includens, Pyrausta nubilalis, Rhyacionia frustrana, Scrobipalpula absoluta, Sitotroga cerealella, Sparganothis pilleriana, Spodoptera spp, such as Spodoptera frugiperda, Spodoptera littoralis, Spodoptera litura; Thaumatopoea pityocampa, Thermesia gemmatalis, Tinea pellionella, Tineola bisselliella, Tortrix viridana, Trichoplusia spp, such as Trichoplusia ni; Tuta absoluta, and Zeiraphera canadensis, beetles (Coleoptera), for example Acanthoscehdes obtectus, Adoretus spp., Agelastica alni, Agrilus sinuatus, Agriotes spp, such as Agriotes fuscicollis, Agriotes lineatus, Agriotes obscurus; Amphimallus solstitialis, Anisandrus dispar, Anobium punctatum, Anomala rufocuprea, Anoplophora spp, such as Anoplophora glabripennis; Anthonomus spp. such as Anthonomus grandis, Anthonomus pomorum; Anthrenus spp., Aphthona euphoridae, Apogonia spp., Athous haemorrhoidalis, Atomaria spp, such as Atomaria linearis; Attagenus spp., Aulacophora femoralis, Blastophagus piniperda, Blitophaga undata, Bruchidius obtectus, Bruchus spp, such as Bruchus lentis, Bruchus pisorum, Bruchus rufimanus; Byctiscus betulae, Callosobruchus chinensis, Cassida nebulosa, Cerotoma trifurcata, Cetonia aurata, Ceuthorhynchus spp, such as Ceuthorrhynchus assimilis, Ceuthorrhynchus napi; Chaetocnema tibialis, Cleonus mendicus, Conoderus spp, such as Conoderus vespertinus; Cosmopolites spp., Costelytra zealandica, Crioceris asparagi, Cryptorhynchus lapathi, Ctenicera ssp, such as Ctenicera destructor; Curculio spp., Dectes texanus, Dermestes spp., Diabrotica spp, such as Diabrotica 12-punctata Diabrotica speciosa, Diabrotica longicornis, Diabrotica semipunctata, Diabrotica virgifera; Epilachna spp, such as Epilachna varivestis, Epilachna vigintioctomaculata; Epitrix spp, such as Epitrix hirtipennis; Eutinobothrus brasiliensis, Faustinus cubae, Gibbium psylloides, Heteronychus arator, Hylamorpha elegans, Hylobius abietis, Hylotrupes bajulus, Hypera brunneipennis, Hypera postica, Hypothenemus spp., Ips typographus, Lachnosterna consanguinea, Lema bilineata, Lema melanopus, Leptinotarsa spp. such as Leptinotarsa decemlineata; Limonius californicus, Lissorhoptrus oryzophilus, Lissorhoptrus oryzophilus, Lixus spp., Lyctus spp, such as Lyctus bruneus; Melanotus communis, Meligethes spp, such as Meligethes aeneus; Melolontha hippocastani, Melolontha melolontha, Migdolus spp., Monochamus spp, such as Monochamus alternatus; Naupactus xanthographus, Niptus hololeucus, Oryctes rhinoceros, Oryzaephilus surinamensis, Otiorrhynchus sulcatus, Otiorrhynchus ovatus, Otiorrhynchus sulcatus, Oulema oryzae, Oxycetonia jucunda, Phaedon cochleariae, Phyllobius pyri, Phyllopertha horticola, Phyllophaga spp., Phyllotreta spp, such as Phyllotreta chrysocephala, Phyllotreta nemorum, Phyllotreta striolata; Phyllophaga spp., Phyllopertha horticola, Popillia japonica, Premnotrypes spp., Psy Modes chrysocephala, Ptinus spp., Rhizobius ventralis, Rhizopertha dominica, Sitona lineatus, Sitophilus spp, such as Sitophilus granaria, Sitophilus zeamais; Sphenophorus spp, such as Sphenophorus levis; Sternechus spp, such as Sternechus subsignatus; Symphyletes spp., Tenebrio molitor, Tribolium spp, such as Tribolium castaneum; Trogoderma spp., Tychius spp., Xylotrechus spp., and Zabrus spp, such as Zabrus tenebrioides, flies, mosquitoes (Diptera), e.g. Aedes spp, such as Aedes aegypti, Aedes albopictus, Aedes vexans; Anastrepha ludens, Anopheles spp, such as Anopheles albimanus, Anopheles crucians, Anopheles freeborni, Anopheles gambiae, Anopheles leucosphyrus, Anopheles maculipennis, Anopheles minimus, Anopheles quadrimaculatus, Anopheles sinensis; Bibio hortulanus, Calliphora erythrocephala, Calliphora vicina, Cerafitis capitata, Ceratitis capitata, Chrysomyia spp. such as Chrysomya bezziana, Chrysomya hominivorax, Chrysomya macellaria; Chrysops atianticus, Chrysops discalis, Chrysops silacea, Cochliomyia spp, such as Cochliomyia hominivorax; Contarinia spp, such as Contarinia sorghicola; Cordylobia anthropophaga, Culex spp, such as Culex nigripalpus, Culex pipiens, Culex quinquefasciatus, Culex tarsalis, Culex tritaeniorhynchus; Culicoides furens, Culiseta inornata, Culiseta melanura, Cuterebra spp., Dacus cucurbitae, Dacus oleae, Dasineura brassicae, Delia spp, such as Delia antique, Delia coarctata, Delia platura, Delia radicum; Dermatobia hominis, Drosophila spp., Fannia spp. such as Fannia canicularis; Gastraphilus spp, such as Gasterophilus intestinalis; Geomyza Tripunctata, Glossina fuscipes, Glossina morsitans, Glossina palpalis, Glossina tachinoides, Haematobia irritans, Haplodiplosis equestris, Hippelates spp., Hylemyia spp, such as Hylemyia platura; Hypoderma spp, such as Hypoderma lineata; Hyppobosca spp., Leptoconops torrens, Liriomyza spp, such as Liriomyza sativae, Liriomyza trifolii; Lucilia spp, such as Lucilia caprina, Lucilia cuprina, Lucilia sericata; Lycoria pectoralis, Mansonia titillanus, Mayetiola spp, such as Mayetiola destructor; Musca spp, such as Musca autumnalis, Musca domestica; Muscina stabulans, Oestrus spp, such as Oestrus ovis; Opomyza florum, Oscinella spp, such as Oscinella frit; Pegomya hysocyami, Phlebotomus argentipes, Phorbia spp, such as Phorbia antiqua, Phorbia brassicae, Phorbia coarctata; Prosimulium mixtum, Psila rosae, Psorophora columbiae, Psorophora discolor, Rhagoletis cerasi, Rhagoletis pomonella, Sarcophaga spp. such as Sarcophaga haemorrhoidalis; Simulium vittatum, Stomoxys spp, such as Stomoxys calcitrans; Tabanus spp, such as Tabanus atratus, Tabanus bovinus, Tabanus lineola, Tabanus similis; Tannia spp., Tipula oleracea, Tipula paludosa, and Wohlfahrtia spp., thrips (Thysanoptera), e.g. Baliothrips biformis, Dichromothrips corbetti, Dichromothrips ssp., Enneothrips flavens, Frankliniella spp, such as Frankliniella fusca, Frankliniella occidentalis, Frankliniella tritici; Heliothrips spp., Hercinothrips fern oral is, Kakothrips spp., Rhipiphorothrips cruentatus, Scirtothrips spp, such as Scirtothrips citri; Taeniothrips cardamoni, Thrips spp, such as Thrips oryzae, Thrips palmi, Thrips tabaci; termites (Isoptera), e.g. Calotermes flavicollis, Coptotermes formosanus, Heterotermes aureus, Heterotermes longiceps, Heterotermes tenuis, Leucotermes flavipes, Odontotermes spp., Reticulitermes spp. such as Reticulitermes speratus, Reticulitermes flavipes, Reticulitermes grassei, Reticulitermes lucifugus, Reticulitermes santonensis, Reticulitermes virginicus; Termes natalensis, cockroaches (Blattaria-Blattodea), e.g. Acheta domesticus, Blatta orientalis, Blattella asahinae, Blattella germanica, Gryllotalpa spp., Leucophaea maderae, Locusta spp., Melanoplus spp., Periplaneta americana, Periplaneta australasiae, Periplaneta brunnea, Periplaneta fuligginosa, Periplaneta japonica, bugs, aphids, leafhoppers, whiteflies, scale insects, cicadas {Hemiptera), e.g. Acrosternum spp, such as Acrosternum hilare; Acyrthosipon spp, such as Acyrthosiphon onobrychis, Acyrthosiphon pisum; Adelges laricis, Aeneolamia spp., Agonoscena spp., Aleurodes spp., Aleurolobus barodensis, Aleurothrixus spp., Amrasca spp., Anasa tristis, Antestiopsis spp., Anuraphis cardui, Aonidiella spp., Aphanostigma piri, Aphidula nasturtii, Aphis spp, such as Aphis fabae, Aphis forbesi, Aphis gossypii, Aphis grossulariae, Aphis pomi, Aphis sambuci, Aphis schneideri, Aphis spiraecola; Arboridia apicalis, Arilus critatus, Aspidiella spp., Aspidiotus spp., Atanus spp., Aulacorthum solani, Bemisia spp, such as Bemisia argentifolii, Bemisia tabaci; Blissus spp, such as Blissus leucopterus; Brachycaudus cardui, Brachycaudus helichrysi, Brachycaudus persicae, Brachycaudus prunicola, Brachycolus spp., Brevicoryne brassicae, Calepitrimerus spp. Such as Calepitrimerus vitis, Calligypona marginata, Calocoris spp., Campylomma livida, Capitophorus horni, Carneocephala fulgida, Cavelerius spp., Ceraplastes spp., Ceratovacuna lanigera, Cercopidae, Cerosipha gossypii, Chaetosiphon fragaefolii, Chionaspis tegalensis, Chlorita onukii, Chromaphis juglandicola, Chrysomphalus ficus, Cicadulina mbila, Cimex spp. such as Cimex hemipterus, Cimex lectularius; Coccomytilus halli, Coccus spp., Creontiades dilutus, Cryptomyzus ribis, Cryptomyzus ribis, Cyrtopeltis notatus, Dalbulus spp., Dasynus piperis, Dialeurades spp., Diaphorina spp., Diaspis spp., Dichelops furcatus, Diconocoris hewetti, Doralis spp., Dreyfusia nordmannianae, Dreyfusia piceae, Drosicha spp., Dysaphis spp, such as Dysaphis plantaginea, Dysaphis pyri, Dysaphis radicola; Dysaulacorthum pseudosolani, Dysdercus spp, such as Dysdercus cingulatus, Dysdercus intermedius; Dysmicoccus spp., Empoasca spp, such as Empoasca fabae, Empoasca solana, Empoasca vitis; Eriosoma spp., Erythroneura spp., Eurygaster spp, such as Eurygaster integriceps; Euscelis bilobatus, Euschistus spp, such as Euschistuos heros, Euschistus impictiventris, Euschistus servus; Geococcus coffeae, Halyomorpha spp, such as Halyomorpha halys; Heliopeltis spp., Homalodisca coagulata, Horcias nobilellus, Hyalopterus pruni, Hyperomyzus lactucae, Icerya spp., Idiocerus spp., Idioscopus spp., Laodeiphax striatellus, Lecanium spp., Lepidosaphes spp., Leptocorisa spp., Leptoglossus phyllopus, Lipaphis erysimi, Lygus spp, such as Lygus hesperus, Lygus lineolaris, Lygus pratensis; Macropes excavatus, Macrosiphum spp, such as Macrosiphum rosae, Macrosiphum avenae, Macrosiphum euphorbiae; Mahanarva fimbriolata, Megacopta cribraria, Megoura viciae, Melanaphis pyrarius, Melanaphis sacchari, Metcafiella spp., Metopolophium dirhodum, Miridae spp., Monellia costalis, Monelliopsis pecanis, Myzus spp, such as Myzus ascalonicus, Myzus cerasi, Myzus persicae, Myzus marians; Nasonovia ribis-nigri, Nephotettix spp, such as Nephotettix malayanus, Nephotettix nigropictus, Nephotettix parvus, Nephotettix virescens; Nezara spp, such as Nezara viridula; Nilaparvata lugens, Oebalus spp., Oncometopia spp., Orthezia praelonga, Parabemisia myricae, Paratrioza spp., Parlatoria spp., Pemphigus spp, such as Pemphigus bursarius; Pentomidae, Peregrinus maidis, Perkinsiella saccharicida, Phenacoccus spp., Phloeomyzus passerinii, Phorodon humuli, Phylloxera spp., Piesma quadrata, Piezodorus spp, such as Piezodorus guildinii, Pinnaspis aspidistrae, Planococcus spp., Protopulvinaria pyriformis, Psallus seriatus, Pseudacysta persea, Pseudaulacaspis pentagona, Pseudococcus spp, such as Pseudococcus comstocki; Psylla spp, such as Psylla mall, Psylla piri; Pteromalus spp., Pyrilla spp., Quadraspidiotus spp., Quesada gigas, Rastrococcus spp., Reduvius senilis, Rhodnius spp., Rhopalomyzus ascalonicus, Rhopalosiphum spp, such as Rhopalosiphum pseudobrassicas, Rhopalosiphum insertum, Rhopalosiphum maid is, Rhopalosiphum padi; Sagatodes spp., Sahlbergella singularis, Saissetia spp., Sappaphis mala, Sappaphis mail, Scaphoides titanus, Schizaphis graminum, Schizoneura lanuginosa, Scotinophora spp., Selenaspidus articulatus, Sitobion avenae, Sogata spp., Sogatella furcifera, Solubea insularis, Stephanitis nashi, Stictocephala festina, Tenalaphara malayensis, Thyanta spp, such as Thyanta perditor; Tibraca spp., Tinocallis caryaefoliae, Tomaspis spp., Toxoptera spp, such as Toxoptera aurantii; Trialeurodes spp, such as Trialeurodes vaporariorum; Triatoma spp., Trioza spp., Typhlocyba spp., Unaspis spp, such as Unaspis yanonensis; and Viteus vitifolii, ants, bees, wasps, sawflies (Hymenoptera), e.g. Athalia rosae, Atta capiguara, Atta cephalotes, Atta cephalotes, Atta laevigata, Atta robusta, Atta sexdens, Atta texana, Bombus spp., Camponotus floridanus, Crematogaster spp., Dasymutilla occidentalis, Diprion spp., Dolichovespula maculata, Hoplocampa spp, such as Hoplocampa minuta, Hoplocampa testudinea; Lasius spp, such as Lasius niger, Linepithema humile, Monomorium pharaonis, Paravespula germanica, Paravespula pennsylvanica, Paravespula vulgaris, Pheidole megacephala, Pogonomyrmex barbatus, Pogonomyrmex californicus, Polistes rubiginosa, Solenopsis geminata, Solenopsis invicta, Solenopsis richteri, Solenopsis xyloni, Vespa spp, such as Vespa crabro, and Vespula squamosa, crickets, grasshoppers, locusts (Orthoptera), e.g. Acheta domestica, Calliptamus italicus, Chortoicetes terminifera, Dociostaurus maroccanus, Gryllotalpa africana, Gryllotalpa gryllotalpa, Hieroglyphus daganensis, Kraussaria angulifera, Locusta migratoria, Locustana pardalina, Melanoplus bivittatus, Melanoplus femurrubrum, Melanoplus mexicanus, Melanoplus sanguinipes, Melanoplus spretus, Nomadacris septemfasciata, Oedaleus senegalensis, Schistocerca americana, Schistocerca gregaria, Tachycines asynamorus, and Zonozerus variegatus, arachnids (Arachnida), such as acari, e.g. of the families Argasidae, Ixodidae and Sarcoptidae, such as Amblyomma spp. (e.g. Amblyomma americanum, Amblyomma variegatum, Amblyomma maculatum), Argas spp. (e.g. Argas persicus), Boophilus spp. (e.g. Boophilus annulatus, Boophilus decoloratus, Boophilus microplus), Dermacentor silvarum, Dermacentor andersoni, Dermacentor variabilis, Hyalomma spp. (e.g. Hyalomma truncatum), Ixodes spp. (e.g. Ixodes ricinus, Ixodes rubicundus, Ixodes scapularis, Ixodes holocyclus, Ixodes pacificus), Ornithodorus spp. (e.g. Ornithodorus moubata, Ornithodorus hermsi, Ornithodorus turicata), Ornithonyssus bacoti, Otobius megnini, Dermanyssus gallinae, Psoroptes spp. (e.g. Psoroptes ovis), Rhipicephalus spp. (e.g. Rhipicephalus sanguineus, Rhipicephalus appendiculatus, Rhipicephalus evertsi), Rhizoglyphus spp., Sarcoptes spp. (e.g. Sarcoptes scabiei), and Eriophyidae spp, such as Acaria sheldoni, Aculops spp. (e.g. Aculops pelekassi) Aculus spp. (e.g. Aculus schlechtendali), Epitrimerus pyri, Phyllocoptruta oleivora and Eriophyes spp. (e.g. Eriophyes sheldoni); Tarsonemidae spp, such as Hemitarsonemus spp., Phytonemus pallidus and Polyphagotarsonemus latus, Stenotarsonemus spp.; Tenuipalpidae spp, such as Brevipalpus spp. (e.g. Brevipalpus phoenicis); Tetranychidae spp, such as Eotetranychus spp., Eutetranychus spp., Oligonychus spp., Tetranychus cinnabarinus, Tetranychus kanzawai, Tetranychus pacificus, Tetranychus telarius and Tetranychus urticae; Bryobia praetiosa, Panonychus spp. (e.g. Panonychus ulmi, Panonychus citri), Metatetranychus spp. and Oligonychus spp. (e.g. Oligonychus pratensis), Vasates lycopersici; Araneida, e.g. Latrodectus mactans, and Loxosceles reclusa. And Acarus siro, Chorioptes spp., Scorpio maurus fleas (Siphonaptera), e.g. Ceratophyllus spp., Ctenocephalides felis, Ctenocephalides canis, Xenopsylla cheopis, Pulex irritans, Tunga penetrans, and Nosopsyllus fasciatus, silverfish, firebrat (Thysanura), e.g. Lepisma saccharina and Thermobia domestica, centipedes (Chilopoda), e.g. Geophilus spp., Scutigera spp, such as Scutigera coleoptrata; millipedes {Diplopoda), e.g. Blaniulus guttulatus, Narceus spp., Earwigs {Dermaptera), e.g. Forficula auricularia, lice (Phthiraptera), e.g. Damalinia spp., Pediculus spp, such as Pediculus humanus capitis, Pediculus humanus corporis; Pthirus pubis, Haematopinus spp, such as Haematopinus eurysternus, Haematopinus suis; Linognathus spp, such as Linognathus vituli; Bovicola bovis, Menopon gallinae, Menacanthus stramineus and Solenopotes capillatus, Trichodectes spp., springtails {Collembola), e.g. Onychiurus ssp, such as Onychiurus armatus, They are also suitable for controlling nematodes: plant parasitic nematodes such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species such as Aphelenchoides besseyi; Sting nematodes, Belonolaimus longicaudatus and other Belonolaimus species; Pine nematodes, Bursaphelenchus lignicolus Mamiya et Kiyohara, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Lesion nematodes, Pratylenchus brachyurus, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus, Rotylenchus reniformis and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species such as Tylenchulus semipenetrans; Dagger nematodes, Xiphinema species; and other plant parasitic nematode species.

Examples of further pest species which may be controlled by said composition include: from the class of the Bivaiva, for example, Dreissena spp.; from the class of the Gastropoda, for example, Arion spp., Biomphalaria spp., Bulinus spp., Deroceras spp., Galba spp., Lymnaea spp., Oncomelania spp., Succinea spp.; from the class of the helminths, for example, Ancylostoma duodenale, Ancylostoma ceylanicum, Acylostoma braziliensis, Ancylostoma spp., Ascaris lumbricoides, Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp, such as Haemonchus contortus; Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercora lis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti; from the order of the Isopoda, for example, Armadillidium vulgare, Oniscus asellus, Porcellio scaber; from the order of the Symphyla, for example, Scutigerella immaculata.

Further examples of pest species which may be controlled by said composition include: Anisoplia austriaca, Apamea spp., Austroasca viridigrisea, Baliothrips biformis, Caenorhabditis elegans, Cephus spp., Ceutorhynchus napi, Chaetocnema aridula, Chilo auricilius, Chilo indicus, Chilo polychrysus, Chortiocetes termini fera, Cnaphalocroci medinalis, Cnaphalocrosis spp., Colias eurytheme, Col lops spp., Cornitermes cumulans, Creontiades spp., Cyclocephala spp., Dalbulus maidis, Deraceras reticulatum, Diatrea saccharalis, Dichelops furcatus, Dicladispa armigera, Diloboderus spp, such as Diloboderus abderus; Edessa spp., Epinotia spp., Formicidae, Geocoris spp., Globitermes sulfureus, Gryllotalpidae, Halotydeus destructor, Hipnodes bicolor, Hydrellia philippina, Julus spp., Laodelphax spp., Leptocorsia acuta, Leptocorsia oratorius, Liogenys fuscus, Lucillia spp., Lyogenys fuscus, Mahanarva spp., Maladera matrida, Marasmia spp., Mastotermes spp., Mealybugs, Megascelis ssp, Metamasius hemipterus, Microtheca spp., Mods latipes, Murgantia spp., Mythemina separata, Neocapritermes opacus, Neocapritermes parvus, Neomegalotomus spp., Neotermes spp., Nymphula depunctalis, Oebalus pugnax, Orseolia spp. such as Orseolia oryzae; Oxycaraenus hyalinipennis, Plusia spp., Pomacea canaliculata, Procornitermes ssp, Procornitermes triacifer, Psylloides spp., Rachiplusia spp., Rhodopholus spp., Scaptocoris castanea, Scaptocoris spp., Scirpophaga spp, such as Scirpophaga incertulas, Scirpophaga innotata; Scotinophara spp, such as Scotinophara coarctata; Sesamia spp. such as Sesamia inferens, Sogaella frucifera, Solenapsis geminata, Spissistilus spp., Stalk borer, Stenchaetothrips biformis, Steneotarsonemus spinki, Sylepta derogata, Telehin licus, Trichostrongylus spp.

In a preferred embodiment, the insect pest belongs to Eulecanium spp, Empoasca spp, Phytoptus spp, Calepitrimerus spp, or Tuta spp. In a preferred embodiment, the insect pest is Eulecanium tiliae, Phytoptus avellanae, Empoasca vitis or Calepitrimerus vitis.

In a preferred embodiment, the insect pest is Tuta absoluta.

The plants on which the compositions of the present disclosure can be used are agronomically useful plants, for example for example vegetable, fruit and cereal crops, trees, nuts, vines, flowering plants and ornamental plants. In an embodiment, the plant or a part thereof is selected from the group consisting of Apiaceae, Asteraceae, Brassicaceae, Chenopodiaceae, Convolvulaceae, Cucurbitaceae, Fabaceae, Gramineae, Liliaceae, Polygonaceae, Rosaceae, Solanaceae, Poaceae, the Vitaceae. Thus, in an embodiment, the target plant is selected from crops, cereals, fruits, vegetables, nuts, vines, nursery plants and flowers. In an embodiment, non-limiting examples of target plant include corn, cereals such as rice, wheat, barley, rye, oat, sorghum, millet, triticale, buckwheat, etc.; cotton, soybean, beet, row crops, legumes, grams, sugar cane, tobacco, etc.; oilseeds such as oilseed rape, peanut/groundnut, rapeseed, sunflower, etc.; vegetables: solanaceous vegetables such as eggplant, tomato, pimento, pepper, potato, etc., cucurbit vegetables such as cucumber, pumpkin, zucchini, water melon, melon, squash, gourds, muskmelon, etc., cruciferous vegetables such as radish, white turnip, horseradish, kohlrabi, cabbage, leaf mustard, broccoli, cauliflower, brussels sprouts, kale, etc., asteraceous vegetables such as burdock, crown daisy, artichoke, lettuce, etc, liliaceous vegetables such as green onion, onion, shallot, garlic, and asparagus, ammiaceous vegetables such as carrot, parsley, celery, parsnip, leek, etc., chenopodiaceous vegetables such as spinach, swiss chard, etc., lamiaceous vegetables such as Perilla frutescens, mint, basil, etc.; herbs and spices such as coriander, chamomile, cassia, catnip, clove, cumin, curry, cilantro, cinnamon, cardamom, dill, anise, juniper, lavender, parsley, rosemary, marigold, mustard, nutmeg, fennel, poppy, thyme, vanilla, saffron, poppy, sage, wintergreen, etc.; flowers, foliage plants, turf grasses, fruits: pome fruits such apple, pear, quince, guava, etc, stone fleshy fruits such as peach, plum, nectarine, cherry, apricot, prune, etc., citrus fruits such as orange, lemon, lime, grapefruit, mandarin, malta, kumquat, pummelo, tangerine, tangor, uniq, etc., nuts such as chestnuts, walnuts, hazelnuts, almond, pistachio, cashew nuts, macadamia nuts, pecan nut, cashew nut, hazel nut, pine nut, etc. berries such as caneberry, strawberry, blueberry, cranberry, blackberry, raspberry, coryberry, darrowberry, dewberry, thornless berry, evergreen blackberry, himalayaberry, hullberry, lavacaberry, loganberry, lowberry, lucretiaberry, mammoth blackberry, marionberry, mora, mures deronce, nectarberry, olallieberry, evergreen berry, phenomenalberry, rangeberry, ravenberry, rossberry, dewberry, tayberry, youngberry, zarzamora, aronia berry, currant, elderberry, barberry, gooseberry, honeysuckle, huckleberry, jostaberry, juneberry, lingonberry, salal, seabuckthorn, bayberry, buffaloberry, chokecherry, maypop, mulberry, bearberry, bilberry, cloudberry, muntries, partridgeberry, etc., grape, kaki fruit, kiwi fruit, olive, plum, banana, coffee, date palm, coconuts, papaya, persimmon, avocado, dragon fruit, pomegranate, lychee, jackfruit, pineapple, passionfruit, sapota, etc., trees other than fruit trees; tea, mulberry, flowering plant, trees such as ash, birch, dogwood, eucalyptus, Ginkgo biloba, lilac, maple, Quercus, poplar, Judas tree, Liquidambar formosana, plane tree, zelkova, japanese arborvitae, fir wood, hemlock, juniper, Pinus, Picea, and Taxus cuspidate, etc., other crops such as chive, day lily, Elegans hosta, Fritillaria, gojiberry, okra, pea, hops, beans, guar, radish, amaranth, jute, fenugreek, lentils, chickpea, artichoke, rhubarb, licorice, sweet potato, Dioscorea japonica, colocasia, ornamental grasses (lawn turf, sod, etc.), varieties and cultivars thereof.

In a preferred embodiment, the plant or a part thereof is hazelnut tree or grapevine or a part thereof.

In a preferred embodiment, the plant or a part thereof is tomato or a part thereof.

An embodiment of the present disclosure also provides a use of a liquid composition comprising sulphur for repelling insect pests.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and following examples, but by all embodiments and methods within the scope and spirit of the invention.

### EXAMPLES

### Example 1: Liquid Composition (Suspension Concentrate) Comprising Sulphur

TABLE 1
Suspension concentrate (SC) comprising 57.3% sulphur

| Ingredient | Amount (% w/w) |
|---|---|
| Sulphur (comprising =<1.0% H₂S) | 57.30 |
| Alkylnaphthalenesulfonic acid, polymer with | 3.00 |
| formaldehyde, sodium salt | |
| Xanthan gum | 0.62 |
| Water | 39.08 |
| Total | 100 |

### Example 2: Pest Repellent Effect of a Liquid Composition Comprising Sulphur (Example 1) Against Scales (Eulecanium tiliae L.) on Hazelnut Trees (Corylus avellana L.)

The study was conducted to evaluate the effectiveness of the SC formulation of Sulphur (825 g/L) against (Eulecanium tiliae L.) on hazelnut trees (Corylus avellana L.). Liquid formulation was applied at two dosage rates—6600 g ai/ha of sulphur and 9900 g ai/ha of sulphur. Two applications of the formulation for each dosage rate and reference product—solid formulation of sulphur 80% (WDG)—were carried out at a gap of 1 month.

Applications were done on hazelnut trees with planting arrangement 5m x 5m and the plant height was 4m. The experimental design included randomized complete blocks with 4 trees per plot. The experiment was carried out in 4 replicates. The timing of application was scheduled at the beginning of the neanid scales migration and at the end of the neanid scales migration. The sprayer pressure was set at 0.45 MPa, spraying volume at 1200 L/ha (Flow=2.54 L/min) and 2 cone nozzles were used for the spraying process.

Assessment on twigs: 50 twigs were randomly checked on the trees of each plot, recording the number of scales present on the distal portions. An assessment was carried out 5 months after second application to evaluate the number of fixed scales on twigs. The observations are recorded in Table 2 below.

Assessment on leaves: After the second application, 10 leaves were randomly collected from the trees of each plot (40 leaves/treatment). The number of fixed scales on the collected leaves was recorded at 42 days after application (42 DAA). The observations are recorded in Table 3 below.

The % repellency was calculated as number of scales lesser in the treated sample than the untreated sample (%). The formula used was:

$$\% Repellency = \frac{\begin{matrix}( Number of scales in untreated plot ) - \\ ( Number of scales in treated plot )\end{matrix}}{( Number of scales in untreated plot )} \times 100$$

TABLE 2
Pest repellent effect of a sulphur SC formulation (Example
1) against scales (Eulecanium tiliae L.) on twigs
of hazelnut trees (Corylus avellana L.)

| | | | Number of scales | % Repellency = |
|---|---|---|---|---|
| | | Sulphur | on 50 twig distal | Number of |
| | | dosage | portions | scales lesser |
| Treatment | | rate | (Average of 4 | than untreated |
| no. | Treatment | (g ai/ha) | replicates) | (%) |
| 1 | Untreated | — | 960 | — |
| | check | | | |
| 2 | Sulphur SC | 6600 | 443.3 | 53.82 |
| 3 | Sulphur SC | 9900 | 326.0 | 66.04 |
| 4 | Sulphur | 6600 | 611.8 | 36.27 |
| | WDG | | | |

TABLE 3
Pest repellent effect of a sulphur SC formulation (Example
1) against scales (Eulecanium tiliae L.) on leaves
of hazelnut trees (Corylus avellana L.)

| | | Sulphur | Number of scales | % Repellency = |
|---|---|---|---|---|
| | | dosage | on 10 leaves | Number of |
| Treatment | | rate | (Average of 4 | scales lesser than |
| no. | Treatment | (g ai/ha) | replicates) | untreated (%) |
| 1 | Untreated | — | 36.8 | — |
| | check | | | |
| 2 | Sulphur SC | 6600 | 9.4 | 74.45 |
| 3 | Sulphur SC | 9900 | 5.9 | 83.96 |
| 4 | Sulphur | 6600 | 16.0 | 56.52 |
| | WDG | | | |

### Example 3: Pest Repellent Effect of a Liquid Composition Comprising Sulphur Against Scales (Eulecanium tiliae L.) on Hazelnut Trees (Corylus avellana L.)

The study was conducted to evaluate the effectiveness of the SC formulation of Sulphur (825 g/L) against (Eulecanium tiliae L.) on hazelnut trees (Corylus avellana L.). Three applications of the formulation for each dosage rate of 3300 g ai/ha of sulphur and 6600 g ai/ha of sulphur; and reference product—solid formulation of sulphur 80% (WDG)—were carried out during the pest migration stage.

Applications were done on hazelnut trees with planting arrangement 6m x 6m and the plant height was 2m. The experimental design included randomized complete blocks with 4 trees per plot. The experiment was carried out in 4 replicates. The timing of application was scheduled at the beginning of the neanid scales migration and at the end of the neanid scales migration. The sprayer pressure was set at 1.5 MPa, spraying volume at 400 L/ha (Flow=2.56 L/min) and 1 cone nozzle was used for the spraying process. First application was done at leaves development stage, second application was done at developed leaves stage and third application was done at nuts development stage. The applications were done 15 days apart from the previous application.

Assessment on twigs: 50 twigs were randomly checked on the trees of each plot, recording the number of scales present on the distal portions. Two assessments were carried out to evaluate the number of fixed scales on twigs. First assessment was conducted at 15 days after third application and second assessment was conducted after about 7 months after the fourth application. The observations are recorded in Table 4 and Table 5 below.

The % repellency was calculated as number of scales lesser in the treated sample than the untreated sample (%). The formula used was:

$$\% Repellency = \frac{\begin{matrix}( Number of scales in untreated plot ) - \\ ( Number of scales in treated plot )\end{matrix}}{( Number of scales in untreated plot )} \times 100$$

TABLE 4
Pest repellent effect of a sulphur SC formulation (Example
1) against scales (Eulecanium tiliae L.) on twigs of hazelnut
trees (Corylus avellana L.) - first assessment

| | | | Number of scales | % Repellency = |
|---|---|---|---|---|
| | | Sulphur | on 50 twig | Number of |
| | | dosage | distal portions | scales |
| Treatment | | rate | (Average of 4 | lesser than |
| no. | Treatment | (g ai/ha) | replicates) | untreated (%) |
| 1 | Untreated | — | 30 | — |
| | check | | | |
| 2 | Sulphur SC | 3300 | 23 | 23.33 |
| 3 | Sulphur SC | 6600 | 8 | 73.33 |
| 4 | Sulphur | 6600 | 23 | 23.33 |
| | WDG | | | |

TABLE 5
Pest repellent effect of a sulphur SC formulation (Example
1) against scales (Eulecanium tiliae L.) on twigs of hazelnut
trees (Corylus avellana L.) - second assessment

| | | | Number of scales | % Repellency = |
|---|---|---|---|---|
| | | Sulphur | on 50 twig | Number of |
| | | dosage | distal portions | scales |
| Treatment | | rate | (Average of 4 | lesser than |
| no. | Treatment | (g ai/ha) | replicates) | untreated (%) |
| 1 | Untreated | — | 44 | — |
| | check | | | |
| 2 | Sulphur SC | 3300 | 6 | 86.36 |
| 3 | Sulphur SC | 3300 | 6 | 93.18 |
| 4 | Sulphur | 6600 | 6 | 86.36 |
| | WDG | | | |

### Example 4: Liquid Composition (Suspension Concentrate) Comprising Sulphur

TABLE 6
Suspension concentrate comprising 57.59% sulphur

| Ingredient | Amount (% w/w) |
|---|---|
| Sulphur (comprising =<1.0% H₂S) | 57.59 |
| Alkylnaphthalenesulfonic acid, polymer with | 3.00 |
| formaldehyde, sodium salt | |
| Silica | 0.62 |
| Water | 38.79 |
| Total | 100 |

### Example 5: Liquid Composition (SE) Comprising Sulphur

TABLE 7
SE composition of sulphur

| Ingredient | Amount (% w/w) |
|---|---|
| Water | 42.23 |
| 1,2-Benzisothiazol-3(2H)-one; Sodium hydroxide | 0.62 |
| Sulphur (comprising =<1.0% H₂S) | 9.84 |
| Mineral oil | 41.84 |
| Isodecyl Alcohol Ethoxylated | 5.46 |
| Total | 100 |

### Example 6: Pest Repellent Effect of a Liquid Composition (SE) Comprising Sulphur Against Scales (Eulecanium tiliae L.) on Hazelnut Trees (Corylus avellana L.)

The study was conducted to evaluate the effectiveness of SE composition of Sulphur (96 g/L) against (Eulecanium tiliae L.) on hazelnut trees (Corylus avellana L.). Reference solid formulation of sulphur 80% (WDG) was carried out during the pest migration stage. The SE composition of Sulphur (96 g/L) was applied at the bud break crop stage before the beginning of the development of leaves.

Applications were done on hazelnut trees with planting arrangement 6m x 6m and the plant height was 2m. The experimental design included randomized complete blocks with 4 trees per plot. The experiment was carried out in 4 replicates. The timing of application was scheduled at the beginning of the neanid scales migration and at the end of the neanid scales migration. The sprayer pressure was set at 1.5 MPa, spraying volume at 400 L/ha (Flow=2.56 L/min) and 1 cone nozzle was used for the spraying process.

Assessment on twigs: 50 twigs were randomly checked on the trees of each plot, recording the number of scales present on the distal portions. Two assessments were carried out to evaluate the number of fixed scales on twigs. First assessment was conducted at 15 days after third application and second assessment was conducted after about 7 months after the fourth application. The observations are recorded in Table 8 below.

The % repellency was calculated as number of scales lesser in the treated sample than the untreated sample (%). The formula used was:

$$\% Repellency = \frac{\begin{matrix}( Number of scales in untreated plot ) - \\ ( Number of scales in treated plot )\end{matrix}}{( Number of scales in untreated plot )} \times 100$$

TABLE 8
Pest repellent effect of a sulphur SE formulation
against scales (Eulecanium tiliae L.) on twigs
of hazelnut trees (Corylus avellana L.)

| | | | Number of scales | % Repellency = |
|---|---|---|---|---|
| | | Sulphur | on 50 twig | Number of |
| | | dosage | distal portions | scales lesser |
| Treatment | | rate | (Average of 4 | than untreated |
| no. | Treatment | (g ai/ha) | replicates) | (%) |
| 1 | Untreated | — | 30 | — |
| | check | | | |
| 2 | Sulphur SE | 236.4 | 2.3 | 92.33 |
| 3 | Sulphur | 6600 | 23 | 23.33 |
| | WDG | | | |

### Example 7: Pest Repellent Effect of a Liquid Composition (EC) Comprising Sulphur Against Tuta absoluta in Tomato

Sulphur 825 EC and sulphur 800 WG were tested for its repellent effect on Tuta absoluta in tomato in greenhouse trials. Each sulphur 825 EC and sulphur 800 WG were applied at 4130 g ai/ha. 1 single foliar application was carried out 2 hours before artificial infestation which involved placing control (untreated) and treated potted tomato plants in an enclosure with Tuta adults in an egg laying stage.

Following observations were carried out:
No of laid eggs and eating damage on day of treatment-day of application of sulphur (A00)
Efficacy of laid eggs on leaves-3 days after application (A03), 7 days after application (A07)
Efficacy of laid eggs on underside of leaves-3 days after application (A03), 7 days after application (A07)
Efficacy of laid eggs on above and underside of leaves-3 days after application (A03), 7 days after application (A07)
Efficacy on eating damage-3 days after application (A03), 7 days after application (A07)
Efficacy on larvae-14 days after application (A14)

TABLE 9
Pest repellent effect of a sulphur EC formulation against
Tuta absoluta in tomato in comparison with pest
repellent effect of a sulphur WDG formulation

| Treatment no. | 1 | 2 | 3 |
|---|---|---|---|
| Treatment | Untreated | Sulphur | Sulphur |
| | check | EC | WDG |
| Sulphur dosage rate (g ai/ha)> | — | 4130 | 4130 |
| No. of eggs on or underside of leaf | 0 | 0 | 0 |
| (A00) | | | |
| % Eating damage (A00) | 0 | 0 | 0 |
| No. of eggs on leave (A03) | 14 | 1 | 6 |
| No. of eggs on underside leave (A03) | 28 | 9 | 32 |
| Total No. of eggs on leave and | 42 | 10 | 38 |
| underside leave (A03) | | | |
| % eating damage (A03) | 0 | 0 | 0 |
| No. of eggs on leave (A07) | 48 | 20 | 60 |
| No. of eggs on underside leave (A07) | 55 | 23 | 136 |
| Total No. of eggs on leave and | 103 | 43 | 196 |
| underside leave (A07) | | | |
| % eating damage (A07) | 5 | 1 | 3 |
| No. of larvae in leaf (A14) | 21 | 0 | 18 |

It is evident from the above treatment that the EC formulation of sulphur was able to exert deterrent and preventative effect against Tuta absoluta in tomato.

### Example 8: Liquid Composition (Suspension Concentrate) Comprising Sulphur

TABLE 10
Suspension concentrate (SC) comprising sulphur

| Ingredient | Amount (% w/w) |
|---|---|
| Sulphur | 56.30 |
| H₂S (Hydrogen sulfide) | 1.00 |
| Alkylnaphthalenesulfonic acid, polymer with | 3.00 |
| formaldehyde, sodium salt | |
| Xanthan gum | 0.62 |
| Water | 39.08 |
| Total | 100 |

### Example 9: Liquid Composition (SE) Comprising Sulphur

TABLE 11
SE composition of sulphur

| Ingredient | Amount (% w/w) |
|---|---|
| Water | 41.23 |
| 1,2-Benzisothiazol-3(2H)-one; Sodium hydroxide | 0.62 |
| Hydrogen sulfide | 1.00 |
| Sulphur | 9.84 |
| Mineral oil | 41.84 |
| Isodecyl Alcohol Ethoxylated | 5.46 |
| Total | 100 |

What is claimed is:

1. A method of repelling insect pests comprising contacting a locus, a plant or a part thereof with a liquid composition comprising sulphur.

2. The method as claimed in claim 1, wherein the liquid composition comprising sulphur is applied at a rate of less than 30,000 g ai/ha of sulphur.

3. The method as claimed in claim 1, wherein the liquid composition is used for foliar application, ground application, or application to plant propagation materials.

4. The method as claimed in claim 1, wherein the liquid composition is applied at pre-harvest stage.

5. The method as claimed in claim 1, wherein the insect pests repelled belong to Eulecanium spp, Empoasca spp, Phytoptus spp, Calepitrimerus spp, or Tuta spp.

6. A liquid composition comprising sulphur for use as an insect pest repellant.

7. The liquid composition as claimed in claim 6, wherein the composition comprises sulphur in an amount ranging from about 1% to about 90% of the total weight or volume of the composition.

8. The liquid composition as claimed in claim 6, wherein the composition comprises about 1 g/L to about 1000 g/L of sulphur.

9. The liquid composition as claimed in claim 6, wherein the composition further comprises a sulfide compound, an oil, or combinations thereof.

10. The liquid composition as claimed in claim 9, wherein the sulfide compound is selected from hydrogen sulfide, dimethyl sulfide, copper sulfide, aluminium sulfide, sodium sulfide, mercury sulfide, cadmium sulfide, iron sulfide, zinc sulfide, diallyl sulfide, dimethyl disulfide, allyl methyl sulfide, carbon disulfide, or combinations thereof.

11. The liquid composition as claimed in claim 9, wherein the oil is a vegetable oil selected from olive oil, kapok oil, castor oil, palm oil, sunflower oil, camellia oil, coconut oil, sesame oil, corn oil, rice bran oil, peanut oil, cottonseed oil, soybean oil, rapeseed oil, linseed oil, tung oil, canola oil, corn oil, or combinations thereof; or a mineral oil selected from paraffinum liquidum, petrolatum, cera microcristallina, microcrystalline wax, naphthenes, ozokerite, ceresine isoparaffin, paraffin and synthetic wax, aromatic oils, fuel oil, or combinations thereof.

12. The liquid composition as claimed in claim 9, wherein the amount of sulfide compound in the composition is about 1% w/w or less.

13. The liquid composition as claimed in claim 9, wherein the amount of oil in the composition ranges from about 1% w/w to about 80% w/w.

14. The liquid composition as claimed in claim 6, wherein the composition further comprises an agrochemically suitable excipient.

15. A method of repelling insect pests, comprising contacting a locus, a plant or a part thereof with a liquid composition comprising sulphur, wherein insect pests repelled belong to Eulecanium spp, Empoasca spp, Phytoptus spp, Calepitrimerus spp, or Tuta spp.

16. The use as claimed in claim 15, wherein the liquid composition comprising sulphur is applied at a rate of less than 30,000 g ai/ha of sulphur.
